(19) United States
(12) Patent Application Publication
(10) Pub. No.: US 2007/0086373 A1
(43) Pub. Date: Apr. 19, 2007

(54) Wireless base station with identification function

(75) Inventors: Chih-Wei Yang, Rende Township (TW); Wei-Ting Lai, Sanchong City (TW); Chih-Yang Wang, Jhonghe City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/543,264

(22) Filed: Oct. 5, 2006

(30) Foreign Application Priority Data
Oct. 6, 2005 (TW) 94134999

(51) Int. Cl. H04Q 7/00

(52) U.S. Cl. 370/328

(57) ABSTRACT

A wireless base station wirelessly connecting to an electronic apparatus and maintaining a connection via a first packet includes a main body, a receiver, a micro-processor and a transmitter. The receiver is disposed in the main body for receiving a first signal. The micro-processor is for adjusting a state of at least a reserved bit of the first packet to form a second packet according to the received first signal. The transmitter is for sending out the second packet to replace the first packet.

This application claims the benefit of Taiwan application Serial No. 94134999, filed Oct. 6, 2005 , the subject matter of which is incorporated herein by conference.

### BACKGROUND OF THE INVENTION

1. Field of the Invention

The invention relates in general to a wireless base station, and more particularly to a wireless base station with identification function.

2. Description of the Related Art

Wireless network is a mainstream network at present. Users need not to use a lot of long network lines but a wireless network card for receiving or broadcasting signals on a wireless base station, such as a wireless access point (AP), a router, and so on.

However, due to popularity and convenience of the wireless base station, users can receive signals broadcasted by different wireless base stations via an on-line operation.

Referring to FIG. 1, a schematic diagram of a conventional wireless device is shown. At present, many conference rooms are equipped with wireless projectors having function like a wireless base station. In FIG. 1, three conference rooms 101a˜101c are shown. The conference room 101ahas a PJT-01a wireless projector 103a, the conference room 101b has a PJT-01b wireless projector 103b and the conference room 101c has a PJT-01cwireless projector 103c. The symbols PJT-01a, PJT-01b and PJT-01c are service set identifiers (SSID). When the user receives signals from a wireless network via a computer 105, the three SSIDs PJT-01a, PJT-01b and PJT-01 are displayed on the computer 105. If there exist other wireless base stations in the neighborhood of the computer 105, more SSIDs of wireless base stations will be displayed on the computer 105. As a result, except that users are very familiar with the names of all wireless base stations or the settings and operations of the wireless network, they will be easily confused about which wireless base station they are using or they have to use and thus can not decide which wireless projector to use as a wireless base station for broadcasting and receiving signals.

### SUMMARY OF THE INVENTION

It is therefore an object of the invention to provide a wireless base station. When users use the wireless network, they can easily identify each of the wireless base stations and thus perform system settings for broadcast and reception of wireless signals conveniently.

The invention achieves the above-identified object by providing a wireless base station wirelessly connecting to an electronic apparatus and maintaining a connection via a first packet. The wireless base station includes a main body, a receiver, a micro-processor and a transmitter. The receiver is disposed in the main body for receiving a first signal. The micro-processor is for modifying a state of at least a reserved bit of the first packet to form a second packet according to the received first signal. The transmitter is for transmitting the second packet to replace the first packet.

The invention achieves the above-identified object by providing a method for identifying a wireless base station, applied to a wireless base station and an electronic apparatus. In the method, first, transmit a first packet from the wireless base station to the electronic apparatus to maintain a connection. Next, trigger the wireless base station and modify a state of at least one reserved bit to form a second packet. Then, transmit the second packet to replace the first packet. Finally, identify the wireless base station according to the second packet.

The invention achieves the above-identified object by providing a wireless network communication system including at least one wireless base station and an electronic apparatus. The wireless base station includes a main body, an access-point identification receiver, a first micro-processor and a first wireless network transmitter. The receiver is disposed in the main body for receiving a first signal. The micro-processor is for modifying a state of a reserved bit of the first packet to form a second packet according to the received first signal. The electronic apparatus receives the second packet, analyzes the second packet, and then identifies the at least one wireless base station according to the second packet.

The invention achieves the above-identified object by providing a method for operating a wireless communication system. The method includes triggering an event for providing a first signal via a user; receiving the first signal via a receiver of the wireless base station; adjusting a state of at least a reserved bit of the first packet via a micro-processor of the wireless base station; broadcasting the adjusted first packet via the wireless base station; receiving the first packet broadcasted by the wireless base station via the computer; decoding the analyzing the first packet via the computer; determining whether a reserved-bit state of the first packet is adjusted via the computer; marking a name of the wireless base station on the computer; and waiting for receiving a next packet by setting the computer in a standby mode.

Other objects, features, and advantages of the invention will become apparent from the following detailed description of the preferred but non-limiting embodiments. The following description is made with conference to the accompanying drawings.

### BRIEF DESCRIPTION OF THE DRAWINGS

FIG. 1 is a schematic diagram of a conventional wireless device.

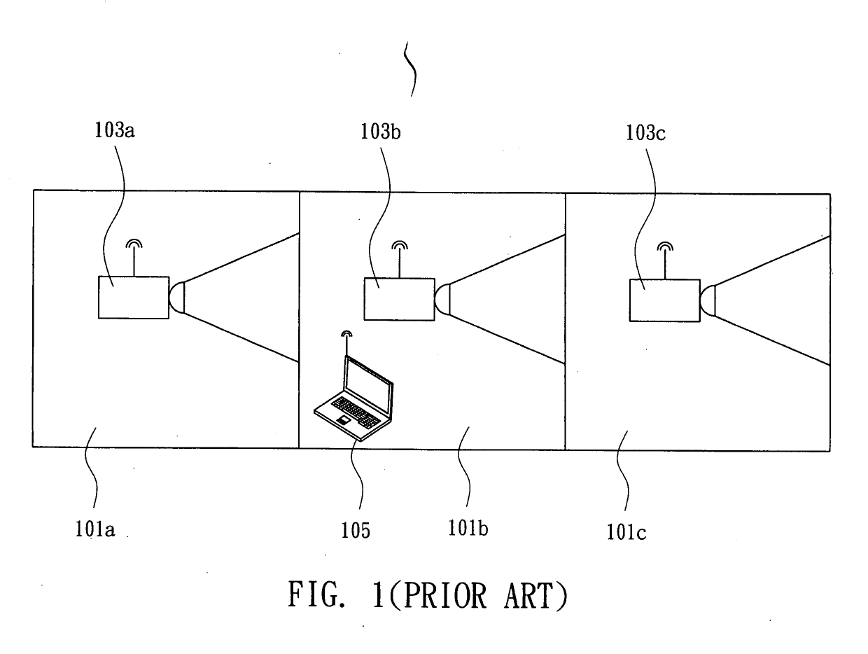

FIG. 2 is a schematic diagram of three wireless base stations in communication with a computer.

FIG. 3 is a flow chart of a method for broadcasting from a wireless base station.

FIG. 4 is a flow chart of the method for a computer to receive packets broadcasted by a wireless base station.

### DETAILED DESCRIPTION OF THE INVENTION

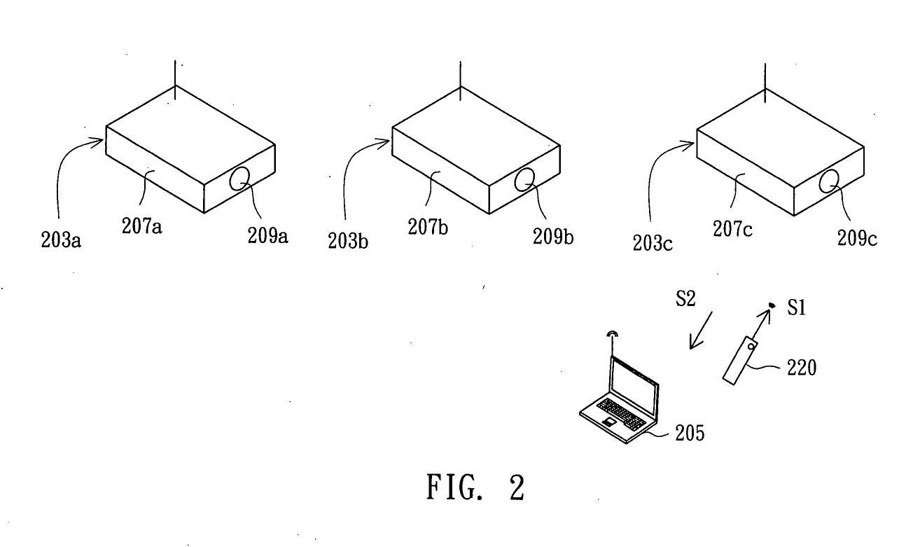

Referring to FIG. 2, a schematic diagram of three wireless base stations in communication with a computer is shown. The three wireless base stations 203a, 203b and 203c respectively have main bodies 207a, 207b and 207c and receivers 209a, 209b and 209c. Each of the wireless base stations 203a˜203c has a micro-processor. The wireless base station is a wireless projector, a wireless broadband router or a wireless router. The above mentioned wireless base stations 203a, 203b, and 203c are exemplified as wireless access points (AP), routers, and so on. The receivers 209a, 209b, and 209c are exemplified as access point identification receivers.

A notebook computer 205 is used to receive signals from the three wireless base stations 203a˜203c. The notebook computer 205 acquires the user which wireless base station is used as a main source of signals. If the user does not know how the three wireless base stations displayed on the computer 205 correspond to the practical three wireless base stations 203a˜203c, the problem can be solved by using the following method.

For example, when the user would like to use the wireless base station 203c, he/she can press a key of the wireless base station 203c or send out a first signal S1 toward the wireless base station 203c by using a remote controller 220. After the key-pressing operation is performed on the wireless base station 203c or the first signal S1 of the remote controller 220 is received by the wireless base station 203c, a second signal S2 is sent back to the notebook computer 205 for notifying the user that the broadcast signal is received by the wireless base station 203c.

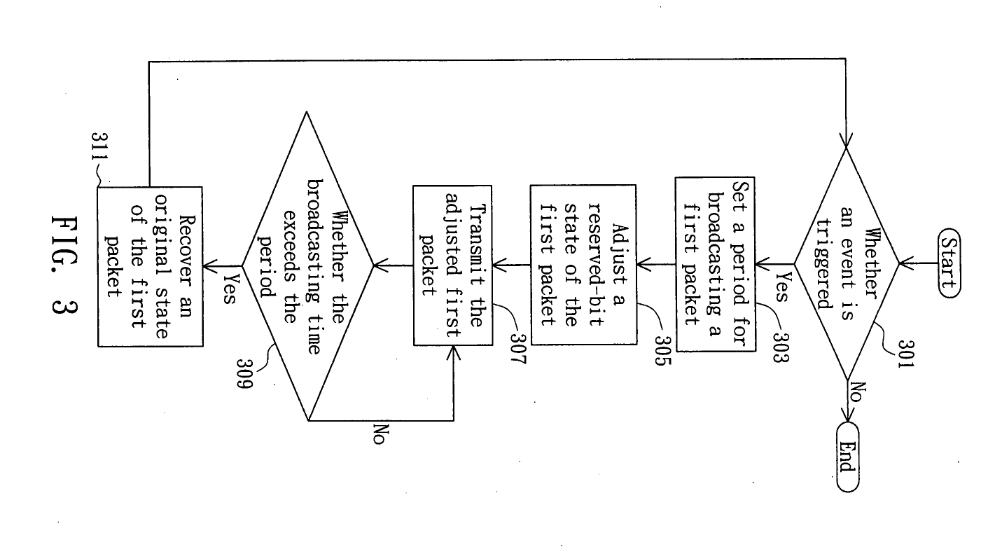

In the following description, a mechanism for broadcasting signals from the wireless base station 203c to the notebook computer 205 is illustrated. Referring to FIG. 3, a flow chart of a method for broadcasting from a wireless base station is shown. With respect to the wireless base-station 203, it needs only to determine whether the received event is triggered in order to decide the subsequent steps. Therefore, first, in step 301, the wireless base station 203c determines whether an event is triggered. If no, the process is ended and the wireless base station 203c waits for a next event to be triggered. If yes, proceed to the step 303, in which the wireless base station 203c sets a period for broadcasting a first packet. The first packet is periodically transmitted to the notebook computer 205 according to the period. Next, in step 305, the micro-processor adjusts a reserved-bit state of the first packet. Following that, in step 307, the wireless base station 203c broadcasts the adjusted first packet via an embedded transmitter. Then, in step 309, determine whether the broadcasting time has exceeds the period for broadcasting the first packet. If no, return to the step 307 to continuously broadcast the adjusted first packet. If yes, execute a step 311 to recover an original state of the first packet and return to the step 301 to wait for a next event to be triggered for subsequently broadcasting a second packet or a third packet.

In the step 301, an event is triggered means that the key of the wireless base station is pressed or a signal is sent to the wireless base station from a control device, such as a remote controller, via a user. In addition, in step 305, the packet is a unit for broadcast communication. The packet includes ten layers, such as a first layer of timestamp, a second layer of beacon interval, a third layer of compatibility information, a fourth layer of SSID. The third layer of compatibility information includes reserved bits (as shown in Table 1) wherein the compatibility information B0˜B15 is for describing compatibility of packet units and mechanism of network security. Some bits of the information B5˜B15 can be adjusted to meet users' different requirements. That is, the state of a reserved bit can be adjusted by changing the address of the reserved bit to trigger a corresponding event.

TABLE 1

| | | | | | |
|---|---|---|---|---|---|
| B0 | B1 | B2 | B3 | B4 | B5->B15 (reserved bits) |

The above-mentioned steps are performed for broadcasting signals from the wireless base station. In the following description, a process of receiving wireless base station broadcast signals by a notebook computer is

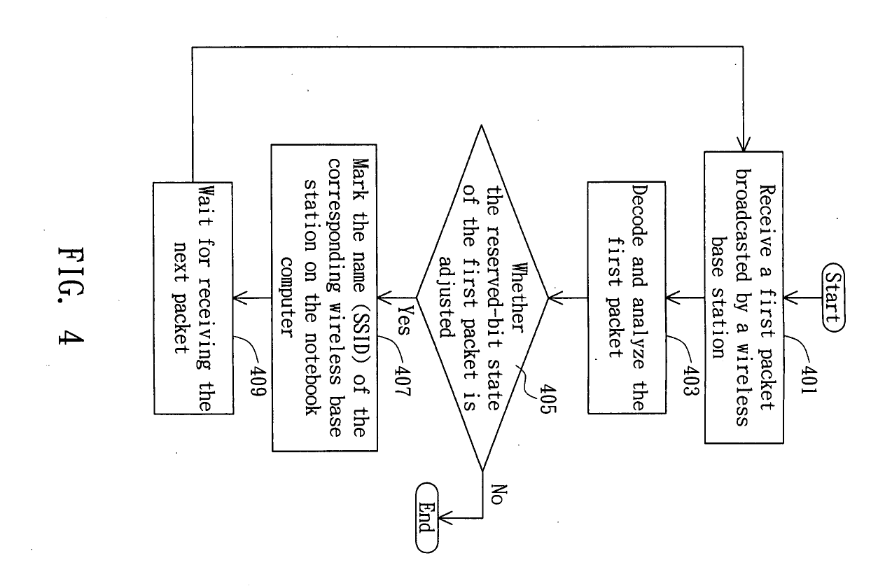

shown. Referring to FIG. 4, a flow chart of the method for a computer to receive packets broadcasted by a wireless base station is shown. First, in step 401, receive a first packet from a wireless base station. Following that, in step 403, decode and analyze the first packet. Next, in step 405, determine whether the reserved-bit state of the first packet is adjusted. If no, the process is ended. If yes, proceed to a step 407 to mark the name (SSID) of the corresponding wireless base station on the notebook computer 205 by identifying and analyzing the first packet. Finally, in step 409, set the notebook computer in a standby mode to wait for a next packet to be received.

In step 407, the name of the corresponding wireless base station can be displayed on a screen of the notebook computer 205 in a reverse-video way, marked with a circle, or selected by a cursor to achieve the purpose of identifying the various wireless base stations communicating with the notebook computer 205.

The wireless base station disclosed by the above-mentioned embodiment of the invention is equipped with a wireless base station identification receiver for users to display the name of the wireless base station to be used on a computer by a key-pressing or remote controlling way. Therefore, the users can accordingly determine the name of each wireless base station so as to decide which wireless base station to select as a medium for broadcasting and receiving signals, thereby improving product convenience.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless base station wirelessly connecting to an electronic apparatus and maintaining a connection via a first packet, comprising:
a main body;
a receiver, disposed in the main body for receiving a first signal;
a micro-processor, for modifying a state of at least a reserved bit of the first packet to form a second packet according to the received first signal; and
a transmitter, for transmitting the second packet to replace the first packet.

2. The wireless base station according to claim 1, further comprising a key, wherein the first signal is generated by pressing the key.

3. The wireless base station according to claim 1, wherein further comprising a remote controller and the receiver is for receiving the first signal generated by the remote controller.

4. The wireless base station according to claim 1, wherein the first packet is periodically transmitted to the electronic apparatus according to a first period.

5. The wireless base station according to claim 4, wherein the second packet is continuously transmitted until the end of the first period, and then the first packet is transmitted periodically.

6. The wireless base station according to claim 1, wherein the first packet comprising a compatibility information and the reserved bit.

7. The wireless base station according to claim 1, further comprising:
a display unit, disposed in the main body for receiving and displaying a frame transmitted by the electronic apparatus.

8. The wireless base station according to claim 7, wherein the display unit is a projecting apparatus.

9. A method for identifying a wireless base station, applied to a wireless base station and an electronic apparatus, the method comprising steps of:
transmitting a first packet from the wireless base station to the electronic apparatus to maintain a connection;
triggering the wireless base station and modifying a state of at least one reserved bit to form a second packet;
transmitting the second packet to replace the first packet; and
identifying the wireless base station according to the second packet.

10. The method according to claim 9, wherein the first packet is transmitted to the electronic apparatus according to a first period.

11. The method according to claim 10, wherein the second packet is continuously transmitted to the electronic apparatus until the end of the first period.

12. The method according to claim 11, wherein at the end of the first period, the first packet is transmitted to replace the second packet.

13. The method according to claim 9, wherein the electronic apparatus comprises a display unit for displaying information of the wireless base station, and after the electronic apparatus receives the second packet, the information is displayed on the display unit.

14. The method according to claim 13, wherein the information is displayed in a reverse-video way, marked with a circle, or selected by a cursor on the display unit.

15. The method according to claim 9, wherein the electronic apparatus utilizes a first wireless base station as a main source, the method further comprising:
the electronic apparatus receiving the second packet from the wireless base station and selecting the wireless base station as the main source.

16. A wireless network communication system, comprising:
at least one wireless base station wirelessly connecting to an electronic apparatus and maintaining a connection via a first packet, wherein the wireless base station comprises:
a main body;
a receiver, disposed in the main body for receiving a first signal;
a micro-processor, for modifying a state of a reserved bit of the first packet to form a second packet according to the received first signal; and
a first transmitter, for transmitting the second packet to replace the first packet; and
an electronic apparatus, for identifying the at least one wireless base station according to the second packet.

17. The wireless network communication system according to claim 16, wherein the wireless base station further comprises a key, and the first signal is generated by pressing the key.

18. The wireless network communication system according to claim 16, wherein the wireless base station further comprises a remote controller and the receiver is for receiving the first signal generated by the remote controller.

19. The wireless network communication system according to claim 16, wherein the first packet is periodically transmitted to the electronic apparatus according to a first period.

20. The wireless network communication system according to claim 19, wherein the second packet is continuously transmitted until the end of the first period, and then the first packet is transmitted periodically.

21. The wireless base station according to claim 16, wherein the first packet comprising a compatibility information and the reserved bit.

22. The wireless network communication system according to claim 16, wherein the wireless base station further comprises:
a display unit, disposed in the main body for receiving and displaying a frame transmitted by the electronic apparatus.

23. The wireless network communication system according to claim 16, wherein the display unit is a projecting apparatus.

24. A method for identifying a wireless base station in a wireless communication system, the wireless communication system comprising at least one wireless base station and an electronic apparatus, the method comprising steps of:
transmitting a first packet from the wireless base station to the electronic apparatus to maintain a connection;
triggering the wireless base station and modifying a state of at least one reserved bit to form a second packet;
transmitting the second packet to replace the first packet;
the electronic apparatus identifying the at least one wireless base station according to the second packet.

25. The method according to claim 24, wherein the first packet is transmitted to the electronic apparatus according to a first period.

26. The method according to claim 25, wherein the second packet is continuously transmitted to the electronic apparatus until the end of the first period.

27. The method according to claim 26, wherein at the end of the first period, the first packet is transmitted to replace the second packet.

28. The method according to claim 24, wherein the electronic apparatus comprises a display unit for displaying information of the wireless base station, and after the electronic apparatus receives the second packet, the information is displayed on the display unit.

29. The method according to claim 28, wherein the information is displayed in a reverse-video way, marked with a circle, or selected by a cursor on the display unit.

30. The method according to claim 24, wherein the electronic apparatus utilizes a first wireless base station as a main source, the method further comprising:
the electronic apparatus receiving the second packet from the wireless base station and selecting the wireless base station as the main source.

31. A computer, for receiving a first packet broadcasted by a wireless base station, characterized in that:
the computer decodes and analyses the first packet to determine whether a reserved-bit state of the first packet is adjusted and marks a name of the wireless base station on the computer.
